(19) United States
(12) Patent Application Publication
(10) Pub. No.: US 2026/0106068 A1
(43) Pub. Date: Apr. 16, 2026

(54) COIL ELECTRONIC COMPONENT

(71) Applicant: SAMSUNG ELECTRO-MECHANICS CO., LTD., Suwon-si (KR)

(72) Inventors: Han Lee, Suwon-si (KR); Boumseock Kim, Suwon-si (KR); Jongwook Lee, Suwon-si (KR)

(73) Assignee: SAMSUNG ELECTRO-MECHANICS CO., LTD., Suwon-si (KR)

(21) Appl. No.: 19/091,519

(22) Filed: Mar. 26, 2025

(30) Foreign Application Priority Data
Oct. 15, 2024 (KR) 10-2024-0140185

(51) Int. Cl. H01F 27/28; H01F 27/02; H01F 27/29; H01F 27/32; H01F 41/04; H01F 41/10

(52) U.S. Cl. CPC H01F 27/2804; H01F 27/022; H01F 27/29; H01F 27/32; H01F 41/042; H01F 41/10

(57) ABSTRACT

A coil electronic component including: a body including a first portion including a first glass material, and a second portion disposed on one surface of the first portion and including a second glass material; a coil embedded in the first portion; and a lead out terminal embedded in the second portion and the connected to the coil.

### CROSS-REFERENCE TO RELATED APPLICATION

This application claims priority to and the benefit of Korean Patent Application No. 10-2024-0140185 filed in the Korean Intellectual Property Office on Oct. 15, 2024, the entire contents of which are incorporated herein by reference.

### BACKGROUND

### 1. Technical Field

The present disclosure relates to a coil electronic component.

### 2. Description of the Related Art

As power consumption increases as a function of a mobile device has diversified in recent years, a coil electronic component having small loss and excellent efficiency is adopted around power management integrated circuit (PMIC) to increase a battery life in mobile devices.

There is a growing demand for a thin power inductor in order to slim products and increase the degree of freedom in component arrangement. Among them, the thin-film inductor can be manufactured by forming a coil on a support member with sputtering or plating. The support member can be deformed by heat or pressure during a process of manufacturing the thin-film inductor. When the support member is deformed, the alignment of the coil may be distracted, exposing the coil to the outside or causing a short, which may reduce the reliability of the thin-film inductor.

### SUMMARY

One aspect of an embodiment attempts to provide a coil electronic component having enhanced reliability.

However, the problems to be solved by the embodiments of the present disclosure are not limited to the above-mentioned problems, but can be variously extended within the scope of the technical spirit included in the embodiments.

An embodiment of the present disclosure provides a coil electronic component which may include: a body including a first portion including a first glass material, and a second portion including a second glass material, wherein the second portion is disposed on a first surface of the first portion; a coil embedded in the first portion; and a lead out terminal embedded in the second portion and connected to the coil.

The coil is may be in direct contact with the first portion.

The lead out terminal may be in direct contact with the second portion.

The coil electronic component may further include an adhesive layer disposed between the first portion and the second portion.

The coil may be in direct contact with the adhesive layer.

The lead out terminal may penetrate the adhesive layer.

The adhesive layer may include an electrically insulating material.

The electrically insulating material may include an epoxy resin.

The first glass material and the second glass material may include the same glass material.

The coil electronic component may further include a support member disposed in the first portion, and the coil may be disposed on the support member.

The support member may include a fourth glass material, and the first glass material and the fourth glass material include the same glass material.

The first glass material, the fourth glass material, and the second glass material may include the same glass material.

The first glass material and the second glass material may include a photosensitive glass.

The coil electronic component may further include a third portion on a second surface of the first portion to oppose the second portion with the first portion interposed therebetween.

The third portion may include a third glass material.

The first glass material, the second glass material, and the third glass material may include the same glass material.

The coil electronic component may further include an external electrode disposed outside the body and connected to the lead out terminal.

The coil electronic component may further include a surface insulating layer disposed on an outer surface of the body.

Another embodiment of the present disclosure provides a method of manufacturing a coil electronic component including disposing a layer including a second glass material on a coil embedded in a first portion to form a second portion, wherein the first portion includes a first glass material; etching the second portion to form a trench; and filling the trench with a conductive metal to form a lead out terminal.

The layer may include a glass panel, a glass wafer, a glass substrate, or combinations thereof.

The first portion may be made of the first glass material, and the second portion may be made of the second glass material.

The filling of the trench may include plating the trench with the conductive metal.

According to an embodiment, a coil electronic component with enhanced reliability can be provided.

### BRIEF DESCRIPTION OF THE DRAWINGS

FIG. 1 is a perspective view schematically illustrating a coil electronic component according to an embodiment.

FIG. 2 is a schematic cross-sectional view taken along line II-II′ of FIG. 1.

FIG. 3 is a schematic cross-sectional view taken along line III-III′ of FIG. 1.

FIG. 4A is a partial enlarged view illustrating area A of FIG. 2.

FIG. 4B is a partial enlarged view illustrating area B of FIG. 2.

FIG. 5 is a perspective view schematically illustrating a coil electronic component according to another embodiment.

FIG. 6 is a schematic cross-sectional view taken along line VI-VI′ of FIG. 5.

FIG. 7 is a schematic cross-sectional view taken along line VII-VII′ of FIG. 5.

FIGS. 8 to 17 are drawings sequentially illustrating a method for manufacturing a coil electronic component according to an embodiment.

FIGS. 18 to 26 are drawings sequentially illustrating a method for manufacturing a coil electronic component according to another embodiment.

### DETAILED DESCRIPTION

Hereinafter, embodiments of the present disclosure will be described in detail so as to be easily implemented by those skilled in the art, with reference to the accompanying drawings. The drawings and description are to be regarded as illustrative in nature and not restrictive. Like reference numerals designate like elements throughout the specification. In addition, some components are exaggerated or omitted or schematically illustrated in the accompanying drawings, and the size of each component is not fully reflected in the actual size.

It is to be understood that the accompanying drawings are just used for easily understanding the embodiments disclosed in this specification and a technical spirit disclosed in this specification is not limited by the accompanying drawings and all changes, equivalents, or substitutes included in the spirit and the technical scope of the present disclosure are included.

Terms including an ordinary number, such as first and second, are used for describing various components, but the components are not limited by the terms. The terms are used only to discriminate one component from another component.

Further, it will be understood that when an element such as a layer, film, region, or substrate is referred to as being “on” another element, it can be directly on the other element or intervening elements may also be present. In contrast, when an element is referred to as being “directly on” another element, there are no intervening elements present. In addition, to be referred to as “on” or “on” a reference portion is located above or below the reference portion, and does not particularly mean to “above”or “on”the direction opposite to gravity.

Throughout the specification, it should be understood that the term “include” or “have”indicates that a feature, a number, a step, an operation, a component, a part or the combination thereof described in the specification is present, but does not exclude a possibility of presence or addition of one or more other features, numbers, steps, operations, components, parts or combinations thereof, in advance. Accordingly, unless explicitly described to the contrary, the word “comprise”, and variations such as “comprises” or “comprising”, will be understood to imply the inclusion of stated elements but not the exclusion of any other elements.

Further, throughout the specification, “plan view” means that a target part is viewed from the top, and “cross-sectional view” means that a cross section vertically cutting the target part is viewed from the side.

In addition, throughout the specification, the term “connected” does not mean that two or more components are directly connected, but may mean being indirectly connected to the two or more components through other components, and electrically connected, or may be referred to as different names according to a location or function, but may be integrated.

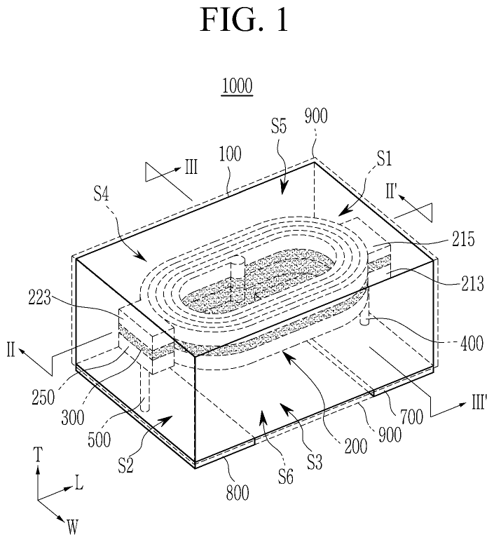

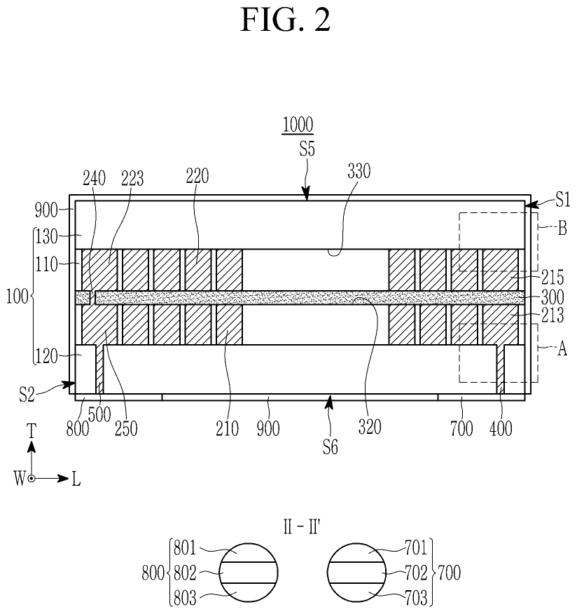

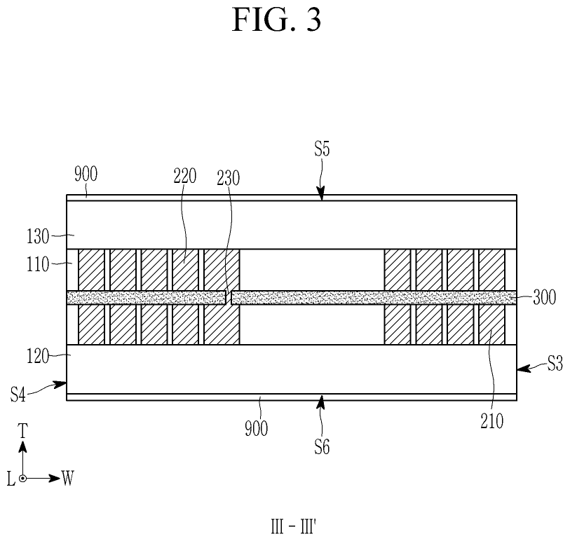

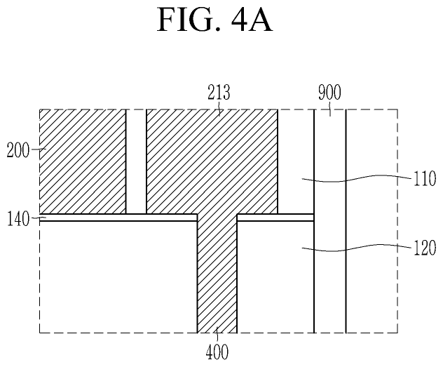

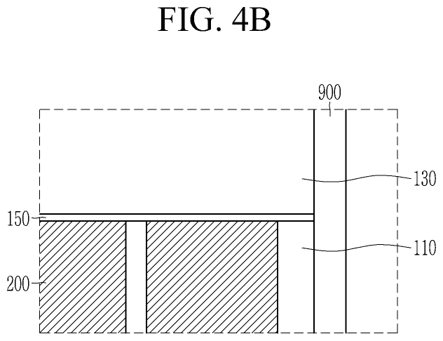

FIG. 1 is a perspective view schematically illustrating a coil electronic component according to an embodiment, FIG. 2 is a schematic cross-sectional view taken along line II-II′ of FIG. 1, FIG. 3 is a schematic cross-sectional view taken along line III-III′ of FIG. 1, FIG. 4A is a partial enlarged view illustrating area A of FIG. 2, and FIG. 4B is a partial enlarged view illustrating area B of FIG. 2.

Referring to FIGS. 1, 2, 3, 4A, and 4B, the coil electronic component 1000 includes a body 100, a coil 200, a support member 300, a first lead out terminal 400, a second lead out terminal 500, a first external electrode 700, a second external electrode 800, and a surface insulating layer 900.

The body 100 may have a substantially rectangular parallelepiped shape, but the embodiment is not limited thereto. For example, the body 100 has a substantially rectangular parallelepiped shape, but portions corresponding to a corner or a vertex may have a round shape.

In the present embodiment, for convenience of description, two surfaces of the body opposing each other in the length direction (L-axis direction) will be defined as a first surface S1 and a second surface S2, two surfaces of the body 100 opposing each other in the width direction (W-axis direction) will be defined as a third surface S3 and a fourth surface S4, and two surfaces of the body 100 opposing each other in the thickness direction (T-axis direction) will be defined as a fifth surface S5 and a sixth surface S6.

A length of the coil electronic component 1000 may mean, based on an optical microscope or a scanning electron microscope (SEM) photograph of a cross-section taken along the length direction (L-axis direction)-thickness direction (T-axis direction) at a center of the coil electronic component 1000 in the width direction (W-axis direction), a maximum value of lengths of a plurality of line segments which connect two outermost boundary lines opposing each other in the length direction (L-axis direction) of the coil electronic component 1000 shown the above-described cross-sectional photograph, respectively, and are parallel to the length direction (L-axis direction). Alternatively, the length of the coil electronic component 1000 may mean a minimum value among lengths of a plurality of line segments which connect two outermost boundary lines opposing each other in the length direction (L-axis direction) of the coil electronic component 1000 shown in the cross-sectional photograph, respectively, and are parallel to the length direction (L-axis direction). Alternatively, the length of the coil electronic component 1000 may mean an arithmetic mean value of lengths of at least two line segments among the plurality of line segments, which connect two outermost boundary lines opposing each other in the length direction (L-axis direction) of the coil electronic component 1000 shown in the above-described cross-sectional photograph, and are parallel to the length direction (L-axis direction), respectively.

A thickness of the coil electronic component 1000 may mean, based on an optical microscope or scanning electron microscope (SEM) photograph of a cross-section taken along the length direction (L-axis direction)-thickness direction (T-axis direction) at a center of the coil electronic component 1000 in the width direction (W-axis direction), a maximum value of lengths of a plurality of line segments which connect two outermost boundary lines opposing each other in the thickness direction (T-axis direction) of the coil electronic component 1000 shown the above-described cross-sectional photograph, respectively, and are parallel to the thickness direction (T-axis direction). Alternatively, the thickness of the coil electronic component 1000 may mean a minimum value among lengths of a plurality of line segments which connect two outermost boundary lines opposing each other in the thickness direction (T-axis direction) of the coil electronic component 1000 shown in the cross-sectional photograph, respectively, and are parallel to the thickness direction (T-axis direction). Alternatively, the thickness of the coil electronic component 1000 may mean an arithmetic mean value of lengths of at least two line segments among the plurality of line segments, which connect two outermost boundary lines opposing each other in the thickness direction (T-axis direction) of the coil electronic component 1000 shown in the above-described cross-sectional photograph, and are parallel to the thickness direction (T-axis direction), respectively.

A width of the coil electronic component 1000 may mean, based on an optical microscope or a scanning electron microscope (SEM) photograph of a cross-section taken along the length direction (L-axis direction)-width direction (W-axis direction) at a center of the coil electronic component 1000 in the thickness direction (T-axis direction), a maximum value of lengths of a plurality of line segments which connect two outermost boundary lines opposing each other in the width direction (W-axis direction) of the coil electronic component 1000 shown the above-described cross-sectional photograph, respectively, and are parallel to the width direction (W-axis direction). Alternatively, the width of the coil electronic component 1000 may mean a minimum value among lengths of a plurality of line segments which connect two outermost boundary lines opposing each other in the width direction (W-axis direction) of the coil electronic component 1000 shown in the cross-sectional photograph, respectively, and are parallel to the width direction (W-axis direction). Alternatively, the width of the coil electronic component 1000 may mean an arithmetic mean value of lengths of at least two line segments among the plurality of line segments, which connect two outermost boundary lines opposing each other in the width direction (W-axis direction) of the coil electronic component 1000 shown in the above-described cross-sectional photograph, and are parallel to the with direction (W-axis direction), respectively.

Each of the length, the width, and the thickness of the coil electronic component 1000 may also be measured using a micrometer measurement method. In the micrometer measurement method, a zero point is set with a micrometer providing repeatability and reproducibility (Gage R&R), the coil electronic component 1000 according to the present embodiment is inserted between tips of the micrometer, and a measuring lever of the micrometer is turned for the measurement. When measuring the length of the coil electronic component 1000 by the micrometer measurement method, the length of the coil electronic component 1000 may mean a value measured once or mean an arithmetic average of values measured a plurality of times. This may be equally applied to measuring the width and the thickness of the coil electronic component 1000.

The body 100 constitutes an exterior of the coil electronic component 1000, and is a space where a magnetic path, which is a path through which the magnetic flux generated by the coil 200 passes, is formed, when a current is applied to the coil 200 through the first external electrode 700 and the second external electrode 800.

The body 100 may surround and encapsulate the coil 200 and the support member 300, and may comprise glass.

For example, the glass included in the body 100 may be SiO₂—B₂O₃-based glass, SiO₂—B₂O₃—K₂O-based glass, SiO₂—B₂O₃ —Li₂O—CaO-based glass, SiO₂—B₂O₃ —Li₂O—CaO—ZnO-based glass, and Bi₂O₃ —B₂O₃—SiO₂—Al₂O₃-based glass. As another example, the body 100 may be made of or may include photosensitive glass including silica, lithium (Li) oxide, aluminum (Al), and cerium (Ce) oxide.

In an embodiment, the glass included in the body 100 may also include filler. The filler included in the glass may include, for example, quartz, alumina, magnesia, silica, forsterite (Mg₂SiO₄), steatite (H₂Mg₃(SiO₃)₄), and zirconia.

The body 100 may include a first portion 110, a second portion 120, and a third portion 130. For example, the body 100 may include the first portion 110, and the second portion 120 and the third portion 130 disposed on either side of the first portion 110 in the thickness direction (T-axis direction).

The coil 200 is embedded in the first portion 110. The first portion 110 may have a substantially rectangular parallelepiped shape. The first portion 110 may be disposed between the second portion 120 and the third portion 130.

The second portion 120 is in contact with one surface of the first portion 110 in the thickness direction (T-axis direction). The first lead out terminal 400 and the second lead out terminal 500 may be disposed in the second portion 120. The second portion 120 may have a substantially rectangular parallelepiped shape.

A first adhesive layer 140 may be disposed between the first portion 110 and the second portion 120.

Referring to FIG. 4A, the first adhesive layer 140 may be in contact with each of the first portion 110 and the second portion 120 of the body 100, and may also be in contact with the coil 200 embedded in the first portion 110. The first lead out terminal 400 may be embedded in the second portion 120, and the first lead out terminal 400 may penetrate the first adhesive layer 140 to be connected to the coil 200. The second lead out terminal 500 may be embedded in the second portion 120, and the second lead out terminal 500 may penetrate the first adhesive layer 140 to be connected to the coil 200.

The third portion 130 is in contact with the other surface of the first portion 110 in the thickness direction (T-axis direction). That is, the third portion 130 and the second portion 120 are disposed on opposite sides of the first portion 110 in the thickness direction (T-axis direction). The third portion 130 may have a substantially rectangular parallelepiped shape.

Referring to FIG. 4B, a second adhesive layer 150 may be disposed between the first portion 110 and the third portion 130.

The second adhesive layer 150 may be in contact with each of the first portion 110 and the third portion 130 of the body 100, and may also be in contact with the coil 200 embedded in the first portion 110.

The first adhesive layer 140 and the second adhesive layer 150 are made of or may include an electrically insulating material. For example, the first adhesive layer 140 and the second adhesive layer 150 may be made of or may include an epoxy resin.

The first portion 110 and the second portion 120 may include glass of the same material. For example, the first portion 110 and the second portion 120 may be made of or may include photosensitive glass. However, the embodiment is not limited thereto.

Meanwhile, the first portion 110, the second portion 120, and the third portion 130 may all include glass of the same material. For example, the first portion 110, the second portion 120, and the third portion 130 may all be made of or may include photosensitive glass. However, the embodiment is not limited thereto.

The support member 300 is disposed inside the body 100, and supports the coil 200. For example, the support member 300 may be embedded in the first portion 110.

When viewed in the thickness direction (T-axis direction), the support member 300 may have the same shape as a shape formed by the edges of the coil 200, or may have a rectangular shape wider than the coil 200. However, the embodiment is not limited thereto.

The support member 300 includes glass. For example, the support member 300 may be made of or may include photosensitive glass. However, the embodiment is not limited thereto.

The support member 300 may include glass made of or may include the same material as any one of the first portion 110, the second portion 120, and the third portion 130 of the body 100.

The support member 300 may include a first support surface 320 and a second support surface 330 opposite each other in the thickness direction (T-axis direction).

The coil 200 is embedded in the body 100 and exhibits the characteristics of the coil electronic component 1000. For example, when the coil electronic component 1000 according to the present embodiment is used as a power inductor, when current is applied to the coil 200, the coil 200 may serve to stabilize the power of an electronic device by storing an electric field in the form of a magnetic field to maintain an output voltage.

When viewed in the thickness direction (T-axis direction), the coil 200 may be spiral.

The coil 200 may be disposed on the first support surface 320 and the second support surface 330 of the support member 300. The coil 200 may include a first coil pattern 210 and a second coil pattern 220, and the first coil pattern 210 and the second coil pattern 220 may be connected to each other through a first via 230. The first coil pattern 210 and the second coil pattern 220 connected in this manner may comprise a spiral coil 200 having one or more turns. The first coil pattern 210 is disposed on the first support surface 320 of the support member 300. The first coil pattern 210 is in contact with the support member 300, the first portion 110, and the first adhesive layer 140. Since the support member 300 and the first portion 110 are made of or may include glass, and the first adhesive layer 140 is made of or may include an electrically insulating material, an insulating film may not be formed on the surface of the first coil pattern 210. That is, the first coil pattern 210 may be in direct contact with the first portion 110.

The first coil pattern 210 includes a first lead out portion 213. The first lead out portion 213 is electrically connected to the first external electrode 700 by the first lead out terminal 400.

A dummy lead out portion 215 may be disposed on the second support surface 330 of the support member 300, which opposes the first lead out portion 213. The dummy lead out portion 215 is for balancing the coil electronic component 1000 in the length direction (L-axis direction) and is therefore not electrically connected to the coil 200. However, in another embodiment, the dummy lead out portion 215 may not be disposed on the support member 300.

The second coil pattern 220 is disposed on the second support surface 330 of the support member 300. The second coil pattern 220 is in contact with the support member 300, the first portion 110, and the second adhesive layer 150. Since the support member 300 and the first portion 110 are made of or may include glass, and the second adhesive layer 150 is made of or may include an electrically insulating material, an insulating film may not be formed on the surface of the second coil pattern 220. That is, the second coil pattern 220 may be in direct contact with the first portion 110.

The second coil pattern 220 includes a second lead out portion 223. A connection portion 250 is disposed on the first support surface 320 of the support member 300, and the connection portion 250 and the second lead out portion 223 oppose each other in the thickness direction (T-axis direction). The connection portion 250 is connected to the second lead out portion 223 through a second via 240. The second lead out portion 223 is electrically connected to the second external electrode 800 by the connection portion 20 and the second lead out terminal 500.

The coil 200, the first via 230, and the second via 240 may be formed of a conductive material such as copper (Cu), aluminum (Al), silver (Ag), tin (Sn), gold (Au), nickel (Ni), lead (Pb), titanium (Ti), or alloys thereof, respectively, but the embodiment is not limited thereto.

Unlike the embodiment, in a coil electronic component that includes a body including a metal magnetic particle and a coil disposed on a support member and embedded in the body, an insulating film is formed which covers a surface of the coil with parylene or the like for insulation between the body and the coil. However, there are defects (e.g., tears, cracks, or compression) in the insulating film between the coils, or if the coils are closely spaced, the insulating film is over-etched due to low resolution. This may result in current leakage in the coils, and when conductive metal is plated to form the coils, the conductive metal may intrude into the gaps in the insulation film and cause a short.

On the other hand, according to the present embodiment, the body 100 with which with the coil 200 is in contact is made of or may include glass, and the glass serves as an insulating film, and glass has higher strength and resolution than polymer such as parylene, reducing the likelihood of current leakage or short circuits in the coil.

The first lead out terminal 400 is disposed inside the second portion 120 of the body 100 and electrically connects the coil 200 to the first external electrode 700.

The first lead out terminal 400 is embedded in the second portion 120 of the body 100.

Since the second portion 120 of the body 100 is made of or may include glass, an insulating film may not be formed on the surface of the first lead out terminal 400. That is, the first lead out terminal 400 may be in direct contact with the second portion 120.

The first lead out terminal 400 may be made of or may include the same material as the coil 200. For example, both the first lead out terminal 400 and the coil 200 may include copper (Cu).

The first lead out terminal 400 may be made of or may include a different material than the coil 200. For example, the coil 200 may include copper (Cu), and the first lead out terminal 400 may include gold (Au), aluminum (Al), silver (Ag), or alloys thereof. When the first lead out terminal 400 is made of or may include a different material than the coil 200, an intermetallic compound may be formed at an interface of the first lead out terminal 400 and the coil 200.

The second lead out terminal 500 is disposed inside the second portion 120 of the body 100 and electrically connects the coil 200 to the second external electrode 800.

The second lead out terminal 500 is embedded in the second portion 120 of the body 100.

Since the second portion 120 of the body 100 is made of or may include glass, an insulating film may not be formed on the surface of the second lead out terminal 500. That is, the second lead out terminal 500 may be in direct contact with the second portion 120.

The second lead out terminal 500 may be made of or may include the same material as the coil 200. For example, both the second lead out terminal 500 and the coil 200 may include the copper (Cu).

The second lead out terminal 500 may be made of or may include a different material than the coil 200. For example, the coil 200 may include the copper (Cu), and the second lead out terminal 500 may include gold (Au), aluminum (Al), silver (Ag), or alloys thereof. When the second lead out terminal 500 is made of or may include a different material than the coil 200, an intermetallic compound may be formed at an interface of the second lead out terminal 500 and the coil 200.

The first external electrode 700 and the second external electrode 800 are disposed outside the body 100, and connected to the coil 200.

The first external electrode 700 may be disposed on the sixth surface S6 of the body 100, and may be connected to the first lead out portion 213 of the coil 200 via the first lead out terminal 400. The second external electrode 800 may be disposed on the sixth surface S6 of the body 100, and may be connected to the connection portion 250 of the coil 200 via the second lead out terminal 500. The first external electrode 700 may include a first metal layer 701, a second metal layer 702, and a third metal layer 703.

The first metal layer 701 may be a plating layer in contact with the first lead out terminal 400 and an outer surface, i.e., the sixth surface S6, of the body 100, and include the copper (Cu). The second metal layer 702 may be a plating layer covering the first metal layer 701, and include nickel (Ni). The third metal layer 703 may be a plating layer covering the second metal layer 702, and include tin (Sn). However, the embodiment is not limited to a three-layer structure, and a two-layer structure with only one metal layer added onto the first metal layer 701 is also possible.

The second external electrode 800 may include a first metal layer 801, a second metal layer 802, and a third metal layer 803.

The first metal layer 801 may be a plating layer in contact with the second lead out terminal 500 and an outer surface, i.e., the sixth surface S6, of the body 100 and include copper (Cu). The second metal layer 802 may be a plating layer covering the first metal layer 801, and include nickel (Ni). The third metal layer 803 may be a plating layer covering the second metal layer 802, and include tin (Sn). However, the embodiment is not limited to a three-layer structure, and a two-layer structure with only one metal layer added onto the first metal layer 801 is also possible.

As another example, the first external electrode 700 and the second external electrode 800 may include a conductive metal and glass. The conductive metal may be, for example, a conductive metal including copper (Cu), nickel (Ni), tin (Sn), palladium (Pd), platinum (Pt), gold (Au), silver (Ag), tungsten (W), titanium (Ti), lead (Pb) alone, or alloys thereof. The glass component included in the first external electrode 700 and the second external electrode 800 may be a mixture of oxides. The glass component may include, for example, a silicon oxide, a boron oxide, an aluminum oxide, a transition metal oxide, an alkaline metal oxide, an alkaline-earth metal oxide, or combinations thereof. Here, the transition metal may be selected from zinc (Zn), titanium (Ti), copper (Cu), vanadium (V), manganese (Mn), iron (Fe), or nickel (Ni), the alkaline metal may be selected from lithium (Li), sodium (Na), or potassium (K), and the alkaline-earth metal may be selected from magnesium (Mg), calcium (Ca), strontium (Sr), or barium (Ba). The method for forming the first external electrode 700 and the second external electrode 800 is not particularly limited. For example, the first external electrode 700 and the second external electrode 800 may be formed by dipping a body 100 into a conductive paste containing metal or glass, or by printing a conductive paste on a surface of the body 100 by, e.g., screen printing method or gravure printing method. Further, various methods, such as applying a conductive paste on the surface of the body 100, or transferring a dry film formed by drying the conductive paste on the body 100, may be used to form the first external electrode 700 and the second external electrode 800.

The surface insulating layer 900 may be disposed on the first surface S1, the second surface S2, the fifth surface S5, and the sixth surface S6 of the body 100. However, the surface insulating layer 900 may partially cover the sixth surface S6 of the body 100. That is, the first external electrode 700 and the second external electrode 800 may be disposed on the sixth surface S6 of the body 100, and the surface insulating layer 900 may not cover the first external electrode 700 and the second external electrode 800.

Meanwhile, the surface insulating layer 900 may also be disposed on the third surface S3 and the fourth surface S4 of the body 100.

As described above, the surface insulating layer 900 is disposed on at least a portion of the first surface S1, the second surface S2, the third surface S3, the fourth surface S4, the fifth surface S5, and the sixth surface S6 of the body 100 to prevent electrical shorts between other electronic components and the first and second external electrodes 700 and 800.

The surface insulating layer 900 may be used as a resist when forming the first external electrode 700 and the second external electrode 800 by electroplating, but is not limited thereto.

The surface insulating layer 900 may include polymer resin, pigment, filler, etc. The polymer resin may include a thermosetting polymer resin such as epoxy or a thermoplastic polymer resin such as acryl. Pigments capable of producing color such as black, may include carbon black, black manganese based spinel powder, etc. and the surface insulating layer may further include additives such as SiO₂ and talc, for control of strength and/or coefficient of thermal expansion.

For example, the surface insulating layer 900 may include a thermoplastic resin such as a polystyrene-based resin, a vinyl acetate-based resin, a polyester-based resin, a polyethylene-based resin, a polypropylene-based resin, a polyamide-based resin, a rubber-based resin, an acryl-based resin, or the like, a thermosetting resin such as a phenol-based resin, an epoxy-based resin, a urethane-based resin, a melamine-based resin, an alkyd-based resin, a photosensitive resin, parylene, SiOₓ or SiNₓ.

The surface insulating layer 900 may be formed through a process such as screen printing, pad printing, dipping, spray printing, etc. For example, the surface insulating layer 900 may be formed by applying a liquid insulating resin to a surface of the body 100, or by stacking an insulating film such as a dry film on the surface of the body 100, or through a thin-film process such as vapor deposition, etc. In the case of the insulating films, Ajinomoto Build-up Film (ABF) or polyimide film, or the like, may be used.

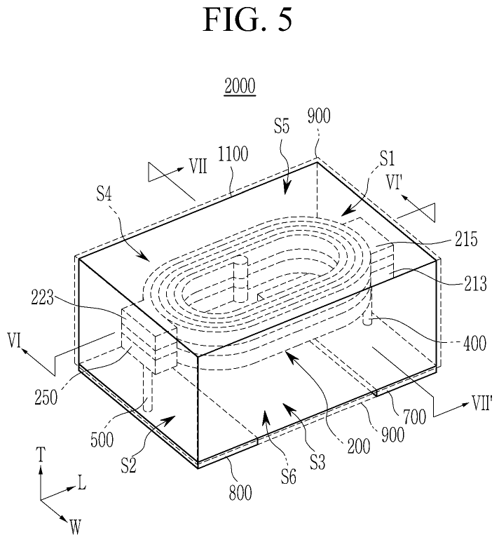

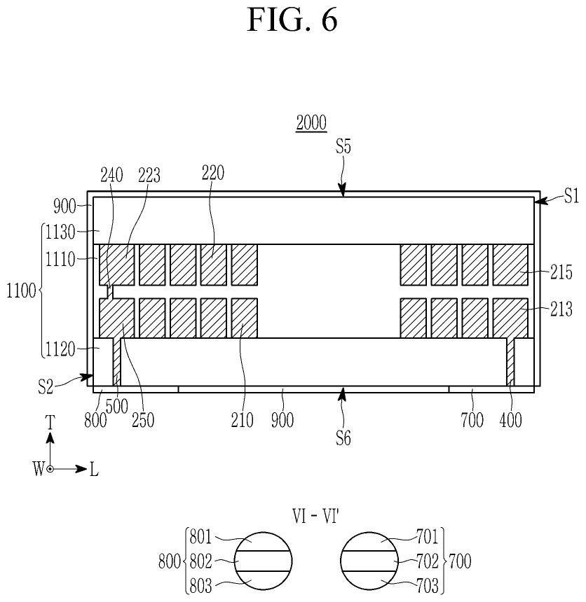

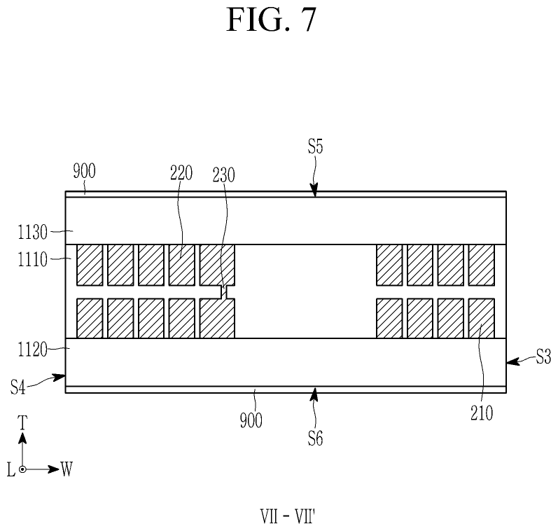

FIG. 5 is a perspective view schematically illustrating a coil electronic component according to another embodiment, FIG. 6 is a schematic cross-sectional view taken along line VI-VI′ of FIG. 5, and FIG. 7 is a schematic cross-sectional view taken along line VII-VII′ of FIG. 5.

Referring to FIGS. 5, 6, and 7, the coil electronic component 2000 includes a body 1100, a coil 200, a first lead out terminal 400, a second lead out terminal 500, a first external electrode 700, a second external electrode 800, and a surface insulating layer 900.

The body 1100 may include a first portion 1110, a second portion 1120, and a third portion 1130. For example, the body 1100 may include the first portion 1110, and the second portion 1120 and the third portion 1130 disposed on either side of the first portion 110 in the thickness direction (T-axis direction).

The coil 200 is embedded in the first portion 1110. The first portion 1110 may be disposed between the second portion 1120 and the third portion 1130.

Unlike the coil electronic component shown in FIG. 1, the support member is not embedded in the first portion 1110 of the coil electronic component 2000 according to the present embodiment. That is, the first portion 1110 of the body 1100 is an integral structure.

The remaining components are the same as the components of the coil electronic components shown in FIG. 1, so a repeated description thereof will be omitted.

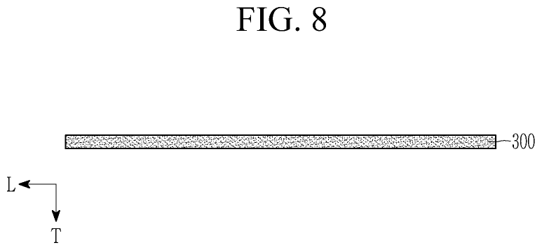

FIGS. 8 to 17 are drawings sequentially illustrating a method for manufacturing a coil electronic component according to an embodiment.

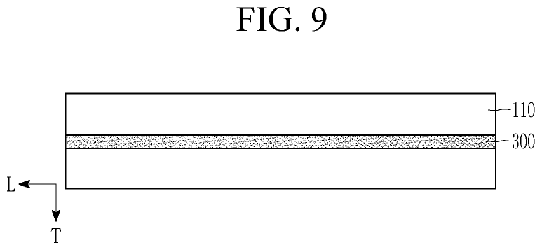

Referring to FIGS. 8 and 9, a support member 300 made of or including glass material is provided, and a first portion 110 made of or including glass material is formed to surround the support member 300. For example, a glass paste or photosensitive glass paste may be applied to a surface of the support member 300 and then cured to form the first portion 110.

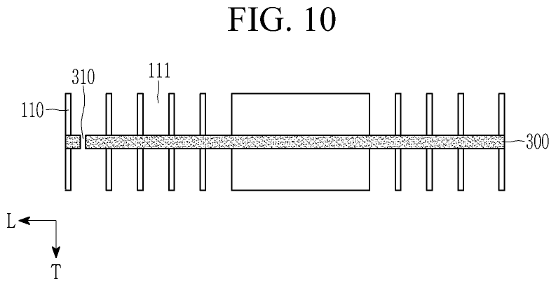

Referring to FIG. 10, a trench 111 and a through-hole 310 are formed by etching the first portion 110. For example, the trench 111 and the through-hole 310 may be formed by irradiating a laser beam onto the first portion 110 and the support member 300 or performing a wet etch process on the first portion 110 and the support member 300.

The trench 111 may be formed in the first portion 110 to have various patterns. For example, the trench 111 may be formed to be spiral.

Since the first portion 110 and the support member 300 are made of or include glass, the trench 111 and the through-hole 310 may be formed to have relatively high aspect ratios. That is, when a laser beam is irradiated onto the first portion 110 and the support member 300 that are made of or include the glass, the straightness of the laser beam is excellent, thereby increasing the aspect ratios of the trench 111 and the through-hole 310. For example, the aspect ratios of the trench 111 and the through-hole 310 may be 3:1 or more or 20:1 or less, respectively. As a result, since the trenches 111 may be disposed in the first portion 110 at a relatively high density, and disposed to be closer to each other with a fine pitch.

Unlike the embodiment, when an insulating film is disposed on the support member, and then a trench is formed by irradiating a laser beam onto the insulating film, it is difficult to increase the aspect ratio of the trench due to scattering of the laser beam. In this case, the pitch of the trench may not be as fine as in the present embodiment.

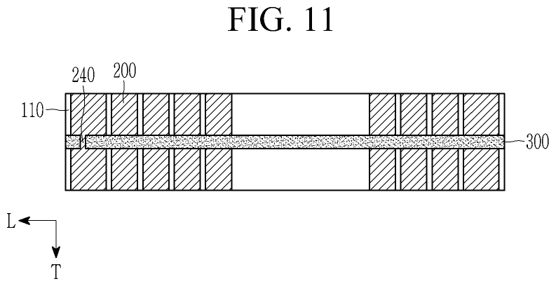

Referring to FIG. 11, a coil 200 is formed by filling the trench 111 and the through-hole 310 with a conductive metal. The conductive metal filled in the trench 111 forms the coil 200, and the conductive metal filled in the through-hole 310 forms a second via 240. For example, the trench 111 and the through-hole 310 may be plated with copper (Cu) to form the coil 200 and the second via 240.

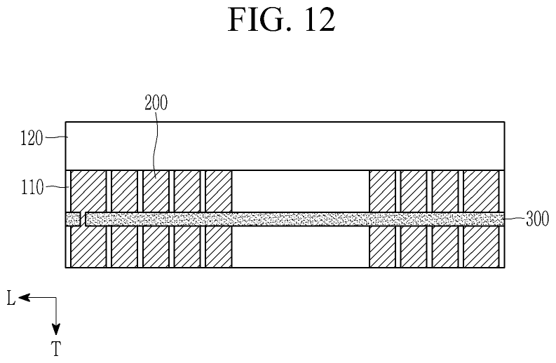

Referring to FIG. 12, a second portion 120 made of or include glass material is formed on one surface of the first portion 110. For example, an adhesive layer made of or include an epoxy resin may be formed on one surface of the first portion 110, and then the second portion 120 may be disposed on the adhesive layer, pressed, and cured. The second portion 120 may be, for example, a glass panel, a glass wafer, or a glass substrate.

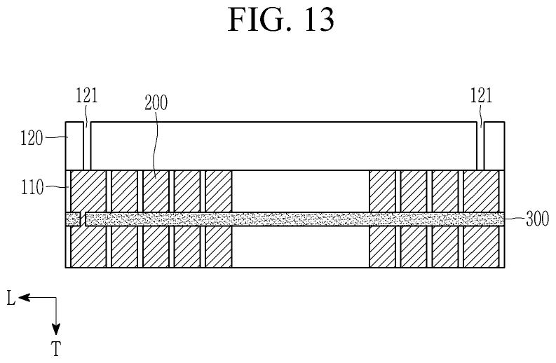

Referring to FIG. 13, a trench 121 is formed by etching the second portion 120.

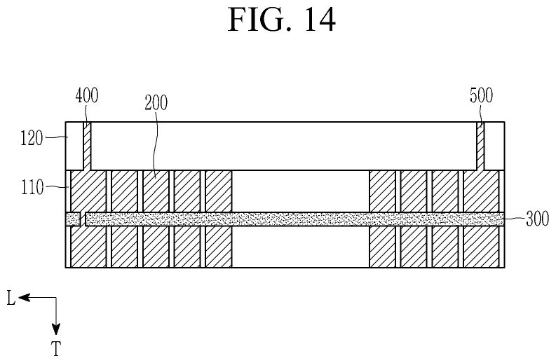

Referring to FIG. 14, the trench 121 is filled with a conductive metal to form a first lead out terminal 400 and a second lead out terminal 500. For example, the trench 121 is plated with copper (Cu) to form the first lead out terminal 400 and the second lead out terminal 500.

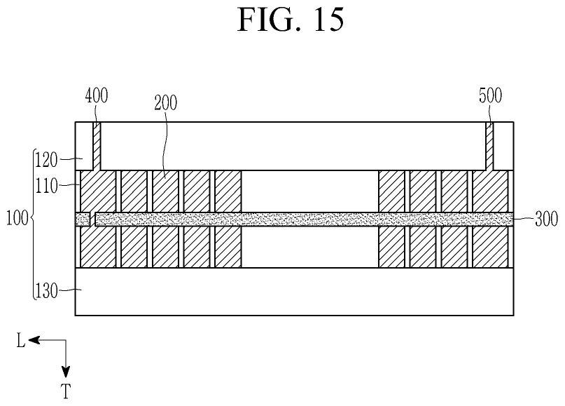

Referring to FIG. 15, a third portion 130 made of or include glass material is formed on the other surface of the first portion 110. For example, an adhesive layer made of or include an epoxy resin may be formed on the other surface of the first portion 110, and then the third portion 130 may be disposed on the adhesive layer, pressed and cured. The third portion 130 may be, for example, a glass panel, a glass wafer, or a glass substrate. As a result, a body 100 is formed.

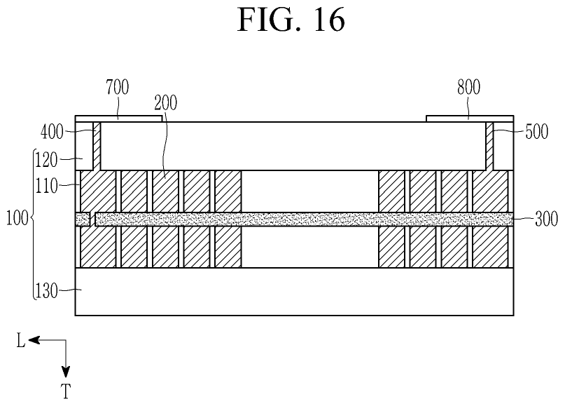

Referring to FIG. 16, a first external electrode 700 and a second external electrode 800 that comprise a conductive metal are formed on an outer surface of the second portion 120. Further, the first external electrode 700 may be formed by plating a conductive metal to be in contact with the first lead out terminal 400, and the second external electrode 800 may be formed by plating a conductive metal to be in contact with the second lead out terminal 500. As a result, the first external electrode 700 is connected to the first lead out terminal 400, and the second external electrode 800 is connected to the second lead out terminal 500.

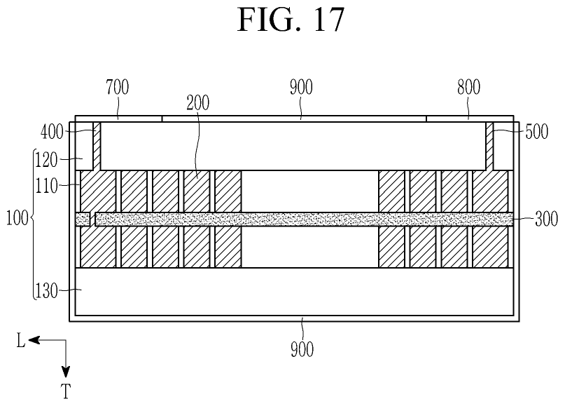

Referring to FIG. 17, a surface insulating layer 900 is formed on an outer surface of the body 100 except where the first external electrode 700 and the second external electrode 800 are formed, thereby manufacturing a coil electronic component 1000.

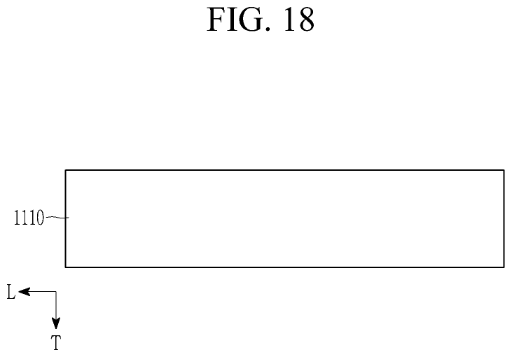

FIGS. 18 to 26 are drawings sequentially illustrating a method for manufacturing a coil electronic component according to another embodiment.

Referring to FIG. 18, a first portion 1110 made of or include glass material is provided. The first portion 1110 may be, for example, a glass panel, a glass wafer, or a glass substrate. The first portion 1110 may have a substantially rectangular parallelepiped shape, but the present embodiment is not limited thereto.

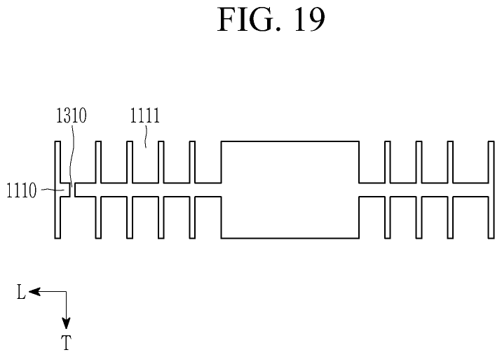

Referring to FIG. 19, a trench 1111 and a through-hole 1310 are formed by etching the first portion 1110. For example, the trench 1111 and the through-hole 1310 may be formed by irradiating a laser beam onto the first portion 1110 or performing a wet etch process on the first portion 1110.

The trench 1111 may be formed in the first portion 1110 to have various patterns. For example, the trench 1111 may be formed to be spiral.

Since the first portion 1110 is made of or include glass, the trench 1111 and the through-hole 1310 may be formed to have relatively high aspect ratios. For example, the aspect ratios of the trench 1111 and the through-hole 1310 may be 3:1 or more or 20:1 or less, respectively. As a result, since the trenches 1111 may be disposed in the first portion 1110 at a relatively high density, and disposed to be closer to each other with a fine pitch.

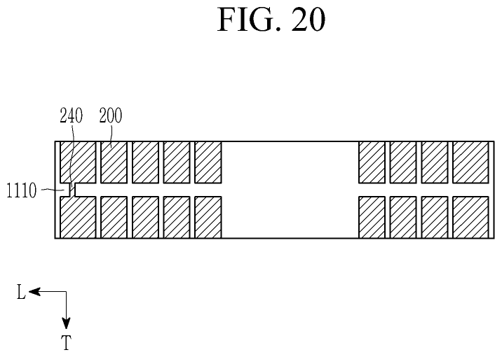

Referring to FIG. 20, a coil 200 is formed by filling the trench 1111 and the through-hole 1310 with a conductive metal. The conductive metal filled in the trench 1111 forms the coil 200, and the conductive metal filled in the through-hole 1310 forms a second via 240. For example, the trench 1111 and the through-hole 1310 are plated with copper (Cu) to form the coil 200 and the second via 240.

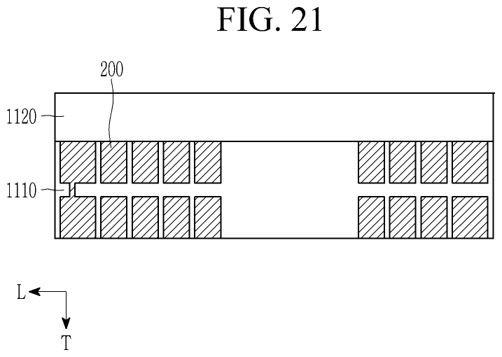

Referring to FIG. 21, a second portion 1120 made of or include glass material is formed on one surface of the first portion 1110. For example, an adhesive layer made of or include an epoxy resin may be formed on one surface of the first portion 1110, and then the second portion 1120 may be disposed on the adhesive layer, pressed and cured. The second portion 1120 may be, for example, a glass panel, a glass wafer, or a glass substrate.

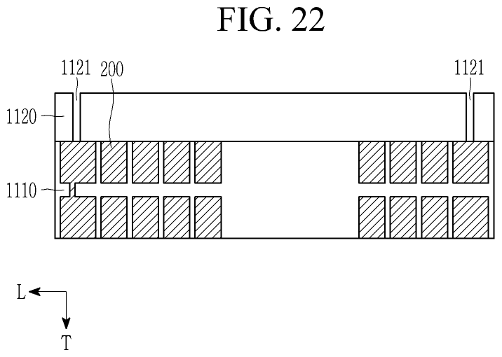

Referring to FIG. 22, a trench 1121 is formed by etching the second portion 1120.

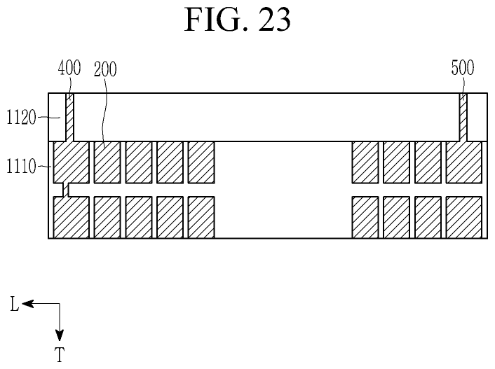

Referring to FIG. 23, the trench 1121 is filled with a conductive metal to form a first lead out terminal 400 and a second lead out terminal 500. For example, the trench 1121 is plated with copper (Cu) to form the first lead out terminal 400 and the second lead out terminal 500.

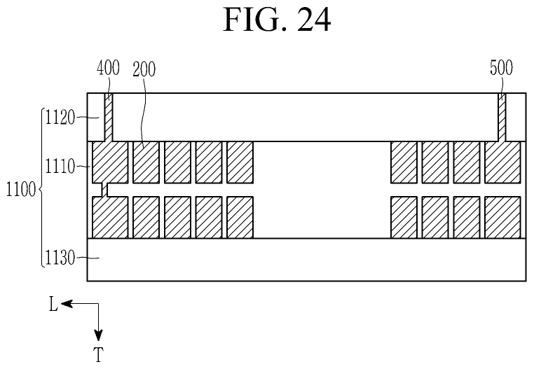

Referring to FIG. 24, a third portion 1130 made of or include glass material is formed on the other surface of the first portion 1110. For example, an adhesive layer made of or include an epoxy resin may be formed on the other surface of the first portion 1110, and then the third portion 1130 may be disposed on the adhesive layer, pressed and cured. The third portion 1130 may be, for example, a glass panel, a glass wafer, or a glass substrate. As a result, a body 1100 is formed.

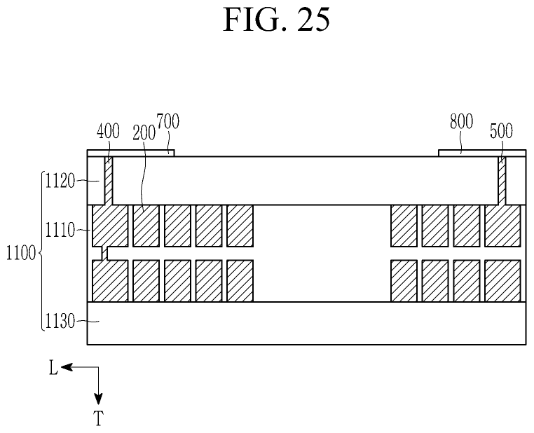

Referring to FIG. 25, the first external electrode 700 and the second external electrode 800 that comprise a conductive metal are formed on the outer surface of the second portion 1120. For example, the first external electrode 700 may be formed by plating a conductive metal to be in contact with the first lead out terminal 400, and the second external electrode 800 may be formed by plating a conductive metal to be in contact with the second lead out terminal 500. As a result, the first external electrode 700 is connected to the first lead out terminal 400, and the second external electrode 800 is connected to the second lead out terminal 500.

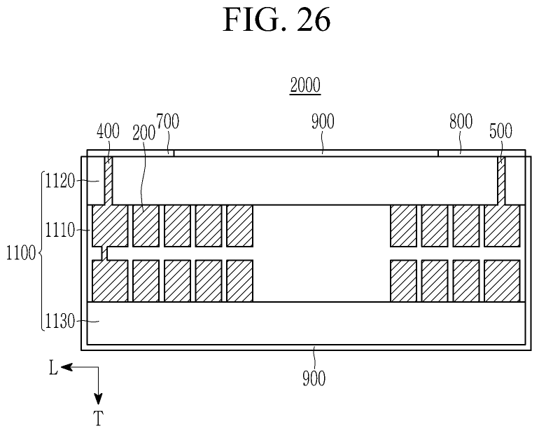

Referring to FIG. 26, a surface insulating layer 900 is formed on the outer surface of the body 1100 except where the first external electrode 700 and the second external electrode 800 are formed, thereby manufacturing a coil electronic component 2000.

Although the embodiment of the present disclosure is described hereinabove, the present disclosure is not limited thereto, and various modifications can be made within the scopes of the claims, and the description of the present disclosure and the accompanying drawings, and belongs to the scope of the present disclosure, of course.

What is claimed is:

1. A coil electronic component comprising:
a body including:
a first portion including a first glass material, and
a second portion including a second glass material, wherein the second portion is disposed on a first surface of the first portion;
a coil embedded in the first portion; and
a lead out terminal embedded in the second portion and connected to the coil.

2. The coil electronic component of claim 1, wherein
the coil is in direct contact with the first portion.

3. The coil electronic component of claim 2, wherein
the lead out terminal is in direct contact with the second portion.

4. The coil electronic component of claim 1, further comprising:
an adhesive layer disposed between the first portion and the second portion.

5. The coil electronic component of claim 4, wherein
the coil is in direct contact with the adhesive layer.

6. The coil electronic component of claim 5, wherein
the lead out terminal penetrates the adhesive layer.

7. The coil electronic component of claim 4, wherein
the adhesive layer includes an electrically insulating material.

8. The coil electronic component of claim 7, wherein
the electrically insulating material includes an epoxy resin.

9. The coil electronic component of claim 1, wherein
the first glass material and the second glass material include the same glass material.

10. The coil electronic component of claim 1, further comprising:
a support member disposed in the first portion,
wherein the coil is disposed on the support member.

11. The coil electronic component of claim 10, wherein
the support member includes a fourth glass material, and
the first glass material and the fourth glass material include the same glass material.

12. The coil electronic component of claim 11, wherein
the first glass material, the fourth glass material, and the second glass material include the same glass material.

13. The coil electronic component of claim 1, wherein
the first glass material and the second glass material include a photosensitive glass.

14. The coil electronic component of claim 1, further comprising:
a third portion on a second surface of the first portion to oppose the second portion with the first portion interposed therebetween.

15. The coil electronic component of claim 14, wherein
the third portion comprises a third glass material.

16. The coil electronic component of claim 15, wherein
the first glass material, the second glass material, and the third glass material include the same glass material.

17. The coil electronic component of claim 1, further comprising:
an external electrode disposed outside the body and connected to the lead out terminal.

18. The coil electronic component of claim 1, further comprising:
a surface insulating layer disposed on an outer surface of the body.

19. A method of manufacturing a coil electronic component comprising:
disposing a layer including a second glass material on a coil embedded in a first portion to form a second portion, wherein the first portion includes a first glass material;
etching the second portion to form a trench; and
filling the trench with a conductive metal to form a lead out terminal.

20. The method of claim 19, wherein the layer includes a glass panel, a glass wafer, a glass substrate, or combinations thereof.

21. The method of claim 19, wherein
the first portion is made of the first glass material, and
the second portion is made of the second glass material.

22. The method of claim 19, wherein the filling of the trench includes plating the trench with the conductive metal.
